(19) United States
(12) Patent Application Publication
(10) Pub. No.: US 2016/0195116 A1
(43) Pub. Date: Jul. 7, 2016

(54) PRESSURE MANAGEMENT SYSTEM FOR STORAGE TANK CONTAINING LIQUEFIED NATURAL GAS

(71) Applicant: Electro-Motive Diesel, Inc., LaGrange, IL (US)

(72) Inventor: Aaron G. Foege, Westmont, IL (US)

(73) Assignee: Electro-Motive Diesel, Inc., LaGrange, IL (US)

(21) Appl. No.: 15/071,093

(22) Filed: Mar. 15, 2016

(51) Int. Cl. F15D 1/00; F17C 13/04

(52) U.S. Cl. CPC F15D 1/0015; F17C 13/04; F17C 2221/033; F17C 2250/0626

(57) ABSTRACT

A pressure management system for a storage tank of liquefied natural gas (LNG) is disclosed. The storage tank includes an outlet, an ullage space, and a condenser coil. The pressure management system includes a boil-off gas (BOG) shut-off valve, an expansion valve, a vortex tube, and a combustor. The BOG shut-off valve connected to the outlet, facilitate passage of a BOG stream when the storage tank is at a threshold pressure. The BOG stream is expanded in the expansion valve and passed through the vortex tube to split the BOG stream into a hot stream and a cold stream. The cold stream is passed through the condenser coil present in the ullage space of the tank to cool and condense the BOG inside the storage tank. The hot stream and the cold stream are combusted in the combustor to produce power.

### TECHNICAL FIELD

The present disclosure relates to storage systems for liquefied natural gas. More particularly, the present disclosure relates to a pressure management system for storage tanks that contain liquefied natural gas.

### BACKGROUND

Natural gas is one of the cleanest burning fuels presently known. Moreover, the current price of natural gas makes it a cost-effective alternative to other fuels. Natural gas, however, can be transformed into liquefied natural gas (LNG). One challenge associated with LNG is a low boiling point of approximately −161° C. LNG is stored at very low temperatures (−160° C.) and low pressures (20 to 150 psi) in a specially designed storage tank, which is insulated and pressure-resistant. Despite the insulation, there may be heat addition to the LNG during storage, transportation, or filling in the storage tank. The heat addition may result in evaporation of the LNG (referred to as boil-off gas) which may cause excessive pressure buildup in the storage tank. Also, generation of the boil-off gas reduces volume in the storage tank available to hold the LNG. Hence, the boil-off gas is required to be removed from the tank.

Different approaches have been taken to address the problem of the boil-off gas that accumulates in the storage tank. One approach has been to vent the boil-off gas from the storage tank into the atmosphere. However, environmental concerns related to potentially negative effects of releasing methane gas into the atmosphere do not make this approach desirable. Furthermore, a considerable amount of the LNG could be wasted if the boil-off gas is simply vented to the atmosphere.

United States Application Number 2015/0000757 discloses a system that maintains a substantially constant pressure within an ullage space of a cryogenic storage tank. However, the system is complex with multiple valves and conduits, which is not only cost intensive but also difficult to maintain.

The present disclosure is directed to overcome one or more of the problems set forth above.

### SUMMARY OF THE DISCLOSURE

Various aspects of the present disclosure are directed towards a pressure management system for a storage tank of liquefied natural gas (LNG). Due to absorption of inherent heat from the surroundings, LNG vapors, referred to as boil-off gas (BOG) are generated inside the storage tank. The storage tank includes an outlet, an ullage space, and a condenser coil. The pressure management system includes a BOG shut-off valve, an expansion valve, and a vortex tube. The BOG shut-off valve is in fluid communication with the outlet of the storage tank. The BOG shut-off valve facilitates passage of a BOG stream, when the storage tank is at a threshold pressure. The expansion valve is positioned downstream to the BOG shut-off valve. The expansion valve is configured to expand the BOG stream, causing the BOG to adiabatically cool. The vortex tube, including an inlet, a hot gas outlet, and a cold gas outlet, is disposed downstream of the BOG shut-off valve. The vortex tube is configured to split the BOG stream into a hot stream and a cold stream and allow them to pass through the hot gas outlet and the cold gas outlet, respectively. The condenser coil is fluidly connected downstream to the cold gas outlet of the vortex tube and positioned in the ullage space of the storage tank. The condenser coil includes a coil inlet and a coil outlet. The condenser coil allows the passage of the cold stream through and absorbs the heat from the BOG inside the storage tank, resulting in the condensation of the BOG. The hot gas outlet and the coil outlet are fluidly connected to the combustor. The combustor burns the hot stream and the cold stream received from the hot gas outlet and the coil outlet, respectively to produce inert exhaust.

### BRIEF DESCRIPTION OF THE DRAWINGS

FIG. 1 is a schematic of an exemplary embodiment of a pressure management system for a storage tank, in accordance with the concepts of the present disclosure; and

FIG. 2 is a schematic of a second embodiment of the pressure management system for the storage tank of FIG. 1, in accordance with the concepts of the present disclosure.

### DETAILED DESCRIPTION

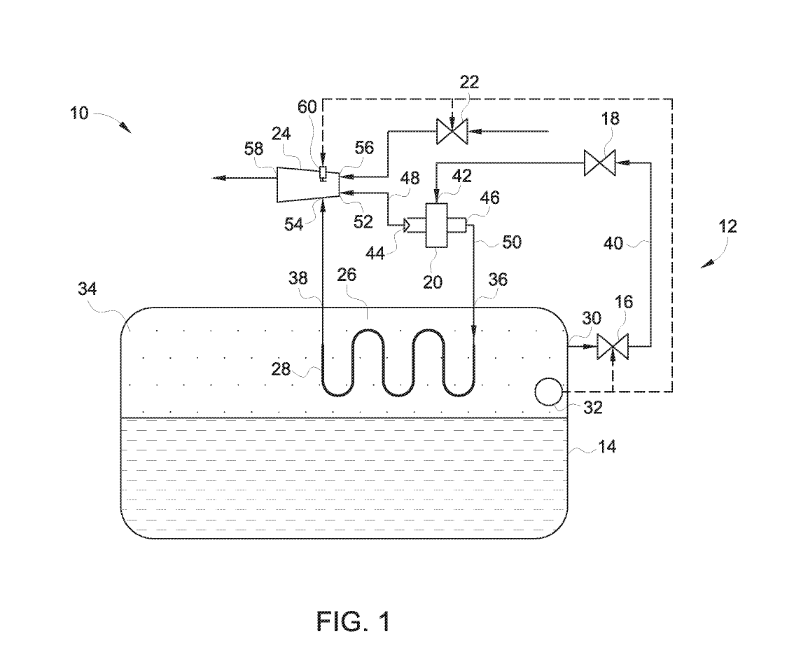

Referring to FIG. 1, there is shown a liquefied natural gas (LNG) storage system 10. The LNG storage system 10 facilitates containment and transportation of LNG. The LNG storage system 10 includes a first pressure management system 12 associated with a storage tank 14. The first pressure management system 12 includes a BOG shut-off valve 16, an expansion valve 18, a vortex tube 20, an air shut-off valve 22, and a combustor 24. The first pressure management system 12 is installed to facilitate maintenance of the storage tank 14 at an optimum pressure.

The storage tank 14 is structured to contain the LNG. The storage tank 14 is thermally insulated and may be composed of a combination of loose-fill perlite and fiberglass blankets. Vapors of LNG are produced inside the storage tank 14 because of the inherent heat from the surroundings. The vapors of LNG are referred to as boil-off gas (BOG) 34. The BOG 34 is contained inside the storage tank 14. The storage tank 14 includes an ullage space 26, a condenser coil 28, an outlet 30, and a pressure switch 32. The ullage space 26 is referred to as an empty space above LNG stored in the storage tank 14. The ullage space 26 contains vapors of the LNG, known as BOG 34. The ullage space 26 also accommodates the condenser coil 28.

The condenser coil 28 is positioned inside the storage tank 14 so as to be in fluid communication with the vortex tube 20 and the combustor 24. The condenser coil 28 includes a coil inlet 36 and a coil outlet 38. The coil inlet 36 is in fluid communication with the vortex tube 20. The coil outlet 38 is in fluid communication with the combustor 24. The condenser coil 28 is structured to allow passage of cold stream 50 to condense the BOG 34 in the ullage space 26.

The outlet 30 allows exit of a portion of the BOG 34 as a BOG stream 40 from the storage tank 14 to the BOG shut-off valve 16.

The pressure switch 32 is in control communication with the BOG shut-off valve 16, the air shut-off valve 22, and the combustor 24. The pressure switch 32 is placed inside the storage tank 14. The pressure switch 32 senses the pressure inside the storage tank 14. On sensing a threshold pressure inside the storage tank 14, the pressure switch 32 actuates the BOG shut-off valve 16 and the air shut-off valve 22.

The BOG shut-off valve 16 is positioned downstream to the outlet 30 of the storage tank 14 and upstream of the expansion valve 18. The BOG shut-off valve 16 is fluidly connected to the outlet 30 of the storage tank 14. The BOG shut-off valve 16 is operated to allow passage of the BOG stream 40 through the outlet 30 and to the expansion valve 18.

The expansion valve 18 is disposed downstream to the BOG shut-off valve 16 and upstream of the vortex tube 20. The expansion valve 18 receives the BOG stream 40 and expands the BOG stream 40, causing the BOG stream 40 to adiabatically cool. The expansion valve 18 delivers the BOG stream 40 to the vortex tube 20.

The vortex tube 20, also known as Ranque-Hilsch vortex tube 20, is disposed downstream to the expansion valve 18 and upstream to the condenser coil 28 and the combustor 24. The vortex tube 20 includes an inlet 42, a hot gas outlet 44, and a cold gas outlet 46. The vortex tube 20 receives the BOG stream 40 through the inlet 42, which is fluidly connected to the expansion valve 18.

The vortex tube 20 is structurally designed to separate the BOG stream 40 into a hot stream 48 and a cold stream 50. The hot stream 48 of the BOG 34 is rejected via the hot gas outlet 44 and the cold stream 50 of the BOG 34 exits via the cold gas outlet 46. The hot gas outlet 44 directs the flow of the hot stream 48 to the combustor 24. The cold gas outlet 46 directs the flow of the cold stream 50 to the coil inlet 36 of the condenser coil 28.

The combustor 24 is positioned downstream to the hot gas outlet 44 of the vortex tube 20. The combustor 24 includes a first fuel inlet 52, a second fuel inlet 54, a combustor air inlet 56, a combustor outlet 58, and an igniter 60. The first fuel inlet 52 is fluidly connected to the hot gas outlet 44 of the vortex tube 20 and receives the hot stream 48 from the hot gas outlet 44. The second fuel inlet 54 is fluidly connected to the coil outlet 38 and receives the cold stream 50 from the condenser coil 28. The combustor air inlet 56 is fluidly connected to the air shut-off valve 22. The air shut-off valve 22 provides compressed air to the combustor 24, via the combustor air inlet 56. The air shut-off valve 22 may be connected to a source of compressed air (not shown). The combustor 24 burns a reactant mixture of the compressed air and the hot stream 48, with the help of the igniter 60, which is mounted inside the combustor 24. The igniter 60 ignites the reactant mixture to produce exhaust gases. The combustor outlet 58 facilitates exit of the exhaust gases to an environment.

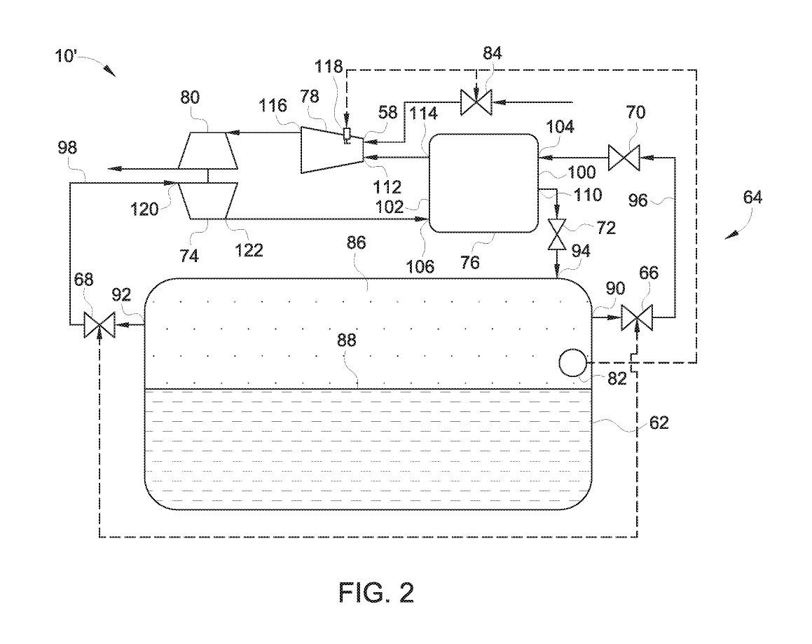

Referring to FIG. 2, there is shown an LNG storage system 10′. The LNG storage system 10′ facilitates containment and transportation of LNG. The LNG storage system 10′ includes a storage tank 62 with a second pressure management system 64 including a first shut-off valve 66, a second shut-off valve 68, a first expansion valve 70, a second expansion valve 72, a compressor 74, a heat exchanger 76, a combustor 78, a turbine 80, and an air shut-off valve 84. The second pressure management system 64 is installed to facilitate maintenance of the storage tank 62 at an optimum pressure.

The storage tank 62 is structured to contain the LNG. The storage tank 62 is thermally insulated and may be composed of a combination of loose-fill perlite and fiberglass blankets. Vapors of LNG are produced inside the storage tank 62 because of the inherent heat from the surroundings. The BOG 86 is contained inside the storage tank 62 above an LNG surface 88. The storage tank 62 includes a pressure switch 82, a first outlet 90, a second outlet 92, and an inlet 94.

The pressure switch 82 is positioned inside the storage tank 62 to measure a pressure of the BOG 86 therewithin. The pressure switch 82 is in control communication with the first shut-off valve 66 and the second shut-off valve 68. The pressure switch 82, at a threshold pressure inside the storage tank 62, sends a signal to the first shut-off valve 66 and the second shut-off valve 68. Also, the pressure switch 82 is in control communication with the air shut-off valve 84 and the combustor 78.

The first outlet 90 and the second outlet 92, split the BOG 86 into a first stream 96 and a second stream 98, respectively. The first outlet 90 allows a passage of the first stream 96 of the BOG 86 to the first shut-off valve 66. The second outlet 92 allows a passage of the second stream 98 of the BOG 86 to the second shut-off valve 68. The inlet 94 facilitates entry of a condensed form of the second stream 98 inside the storage tank 62.

The first shut-off valve 66 is positioned downstream and is fluidly connected to the first outlet 90 of the storage tank 62. The first shut-off valve 66 is configured to vent the first stream 96 of the BOG 86, upon communication by the pressure switch 82. The first shut-off valve 66 allows the flow of first stream 96 of the BOG 86 to the first expansion valve 70.

The second shut-off valve 68 is positioned downstream and is fluidly connected to the second outlet 92 of the storage tank 62. The second shut-off valve 68 is configured to vent the second stream 98 of the BOG 86, upon communication by the pressure switch 82. The second shut-off valve 68 allows the flow of second stream 98 of the BOG 86 to the compressor 74.

The first expansion valve 70 is positioned downstream to the first shut-off valve 66. The first expansion valve 70 is fluidly connected to the first outlet 90 to receive the first stream 96 of the BOG 86. The fluid connection between the first expansion valve 70 and the first outlet 90 may be via an insulated conduit or pipe (not shown). The first expansion valve 70 supplies the first stream 96 to the heat exchanger 76.

The heat exchanger 76, which is a counter flow type, includes a first end 100 and a second end 102. The heat exchanger 76 is positioned downstream to the first expansion valve 70 at the first end 100 and downstream of the compressor 74 at the second end 102.

The heat exchanger 76 includes a first inlet port 104, a second inlet port 106, a first outlet port 108, and a second outlet port 110. Particularly, the first end 100 includes the first inlet port 104 and the second outlet port 110. The first inlet port 104 is structured to allow entry of the first stream 96 inside the heat exchanger 76. The second outlet port 110 facilitates the exit of the second stream 98 from heat exchanger 76 to the second expansion valve 72.

In addition, the second end 102 includes the second inlet port 106 and the first outlet port 108. The second inlet port 106 is in fluid communication with the compressor 74. The second inlet port 106 is structured to allow entry of the second stream 98 inside the heat exchanger 76. The first outlet port 108 facilitates the exit of the first stream 96 from heat exchanger 76 to the combustor 78. The heat exchanger 76 is structurally designed to transfer heat from the second stream 98 of the BOG 86 to the first stream 96 of the BOG 86.

The combustor 78 is positioned downstream to the second end 102 of the heat exchanger 76. The combustor 78 includes a combustor fuel inlet 112, a combustor air inlet 114, a combustor outlet 116, and an igniter 118. The combustor fuel inlet 112 is fluidly connected to the first outlet port 108 of the heat exchanger 76, and receives the first stream 96 of the BOG 86 from the first outlet port 108. The combustor air inlet 114 is fluidly connected to the air shut-off valve 84. The air shut-off valve 84 provides compressed air to the combustor 78, via the combustor air inlet 114. The air shut-off valve 84 may be connected to a source of compressed air (not shown). The combustor 78 burns a reactant mixture of the compressed air and the heated first stream 96, with the help of the igniter 118. The igniter 118 is mounted inside the combustor 78. The igniter 118 ignites the reactant mixture to produce exhaust gases. The combustor outlet 116 directs the exhaust gases to the turbine 80.

The turbine 80 is positioned downstream to the combustor 78. The turbine 80 is connected to the combustor 78 through a transition piece (not shown) to receive the exhaust gases from the combustor 78. The turbine 80 is structurally designed to convert the thermal energy of the exhaust gases to mechanical energy to rotate a shaft (not shown). The turbine 80 is coupled to the compressor 74 by means of the shaft (not shown). The turbine 80 provides power to drive the compressor 74.

The compressor 74 is disposed downstream to the second shut-off valve 68 and upstream of the heat exchanger 76. The compressor 74 includes a compressor inlet 120 and a compressor outlet 122. The compressor inlet 120 receives the second stream 98. The compressor 74 compresses the second stream 98 and delivers the compressed second stream 98 to the heat exchanger 76, via the compressor outlet 122. The second stream 98 leaves the heat exchanger 76 through the second outlet port 110 and flows into the second expansion valve 72.

The second expansion valve 72 is positioned downstream to the first end 100 of the heat exchanger 76. The second expansion valve 72 is fluidly connected to the second outlet port 110 of first end 100. The second expansion valve 72 expands the second stream 98 of the BOG 86, which is received from the second outlet port 110, causing the BOG 86 to adiabatically cool The second expansion valve 72 is connected with the help of an insulated conduit (not shown) to the inlet 94 of the storage tank 62.

### Industrial Applicability

In operation, the disclosed pressure management systems 12 and 64 operate to maintain the storage tanks 14 and 62, at an optimum pressure. When the pressure switch 32 detects that the BOG 34 is at or over the threshold pressure of approximately 165 psi, the pressure switch 32 opens the BOG shut-off valve 16. This allows the passage of the BOG stream 40 to exit the storage tank 14. From the BOG shut-off valve 16, the BOG stream 40 flows to the expansion valve 18, where the BOG stream 40 cools due to adiabatic expansion. The BOG stream 40 leaves the expansion valve 18 to enter the inlet 42 of the vortex tube 20. The vortex tube 20 operates to separate the hot stream 48 and the cold stream 50 from the BOG stream 40. The hot stream 48, thus separated, leaves the vortex tube 20 through the hot gas outlet 44 and flows to the first fuel inlet 52. The separated cold stream 50 leaves the vortex tube 20 through cold gas outlet 46 and flows to the coil inlet 36. The cold stream 50 exiting the cold gas outlet 46 flows to the coil inlet 36. Thereafter, the cold stream 50 flows through the condenser coil 28. While passing through the condenser coil 28, the cold stream 50 condenses the BOG 34 present in the ullage space 26 of the storage tank 14 by absorbing the heat. The condensed BOG 34 adds to a volume of the LNG in the storage tank 14, thereby reducing the pressure inside the storage tank 14. After condensation of the BOG 34, the heated cold stream 50 exits the condenser coil 28, via the coil outlet 38 and flows to the second fuel inlet 54. The combustor 24 receives and burns the hot stream 48 from first fuel inlet 52, the cold stream 50 from the second fuel inlet 54, and the compressed air from the air shut-off valve 22, to produce exhaust gases. The exhaust gases thus produced are inert and are released to the environment.

In operation, in the second embodiment when the pressure switch 82 detects that the BOG 86 is at or over the threshold pressure of approximately 165 pounds per square inch (psi), the pressure switch 82 opens the first shut-off valve 66 and the second shut-off valve 68 to allow the passage of the first stream 96 and the second stream 98 from the storage tank 62. The first stream 96 of the BOG 86 flows through the first shut-off valve 66 to the first expansion valve 70. The first stream 96 is expanded and cooled in the first expansion valve 70. The cooled first stream 96 is then delivered to the first inlet port 104 of the heat exchanger 76. The first stream 96 flows through the heat exchanger 76 and exits the heat exchanger 76 to enter the combustor 78. The combustor 78 burns the first stream 96 to produce exhaust gases, which is inert in nature. The exhaust gases are passed through the turbine 80, which rotates to produce mechanical energy. The turbine 80 in turn rotates and powers the compressor 74. Meanwhile, the second stream 98 of the BOG 86 passes through the second shut-off valve 68, which opens simultaneously with the first shut-off valve 66. The second shut-off valve 68 allows passage of the second stream 98 to the compressor 74, via the compressor inlet 120. The second stream 98 is compressed to a higher temperature and pressure in the compressor 74, which is powered by the turbine 80. The compressed second stream 98 then leaves the compressor 74 via the compressor outlet 122 and enters the heat exchanger 76, via the second inlet port 106. The second stream 98 flows across the cooled first stream 96 already flowing through the heat exchanger 76. The first stream 96 absorbs heat from the second stream 98, while the second stream 98 passes through the heat exchanger 76. After heat rejection, the second stream 98 exits the heat exchanger 76, via the second outlet port 110 and flows through the second expansion valve 72. While flowing through the second expansion valve 72, the second stream 98 adiabatically cools and condenses. The condensed second stream 98 leaves the second expansion valve 72 and enters the storage tank 62 through the inlet 94.

Hence, the disclosed first pressure management system 12 lowers the pressure and temperature inside the storage tank 14. In the present disclosure, the first pressure management system 12 is able to address the problem of the BOG 34 generation with less number of components as compared to the existing solutions. This significantly brings down cost of overall system while the existing systems included complex component arrangement and hence, are expensive to maintain. In addition, the first pressure management system 12 splits the BOG stream 40 into the hot stream 48 and the cold stream 50 with the help of the vortex tube 20. The first pressure management system 12 uses the cold stream 50 for cooling and condensing the BOG 34 inside the storage tank 14 and burn both the hot stream 48 and cold stream 50 to produce power. This way there is no need for additional arrangements for cooling and providing power. Also, the exhaust gases exiting the combustor 24 are rendered inert through previous combustion in the combustor 24. Therefore, there are no unfavourable effects of releasing such greenhouse gases into the environment.

It should be understood that the above description is intended for illustrative purposes only and is not intended to limit the scope of the present disclosure in any way. Thus, one skilled in the art will appreciate that other aspects of the disclosure may be obtained from a study of the drawings, the disclosure, and the appended claim.

What is claimed is:

1. A pressure management system for a storage tank of liquefied natural gas, the storage tank containing a boil-off gas (BOG) generated therein, the storage tank including an ullage space, a condenser coil, and an outlet, the pressure management system comprising:
a BOG shut-off valve located downstream and in fluid communication with the outlet, the BOG shut-off valve facilitates a passage of a boil-off gas stream, when a pressure inside the storage tank is over a threshold pressure;
an expansion valve fluidly coupled and downstream of the BOG shut-off valve adapted to expand and adiabatically cool the BOG stream;
a vortex tube fluidly coupled and disposed downstream of the BOG shut-off valve, the vortex including a hot gas outlet and a cold gas outlet, the vortex tube being configured to receive the BOG stream and split the BOG stream into a hot stream to exit via the hot gas outlet and a cold stream to exit via the cold gas outlet;
a combustor fluidly coupled and positioned downstream of the hot gas outlet of the vortex tube, the combustor adapted to combust the hot stream therewithin,
a condenser coil at least partially disposed in the ullage space of the storage tank, the condenser coil includes a coil inlet in fluid communication with the cold gas outlet and a coil outlet in fluid communication with the combustor, such that the coil inlet receives the cold stream and exits via the coil outlet, wherein the condenser coil is structured to condense the BOG in the ullage space of the storage tank;
wherein the cold stream upon exiting via the coil outlet flows to the combustor, where the cold stream along with the hot stream is combusted with air, to produce inert exhaust.

2. The pressure management system of claim 1, wherein the vortex tube being a Ranque-Hilsch vortex tube.
